(19) United States
(12) Patent Application Publication
(10) Pub. No.: US 2015/0238049 A1
(43) Pub. Date: Aug. 27, 2015

(54) MULTI-ZONED CLAMSHELL CHARBROILER

(71) Applicant: ENODIS CORPORATION, NEW PORT RICHEY, FL (US)

(72) Inventors: Douglas S. JONES, New Port Richey, FL (US); Janice M.K. JAFERIAN, Palm Harbor, FL (US)

(21) Appl. No.: 14/628,078

(22) Filed: Feb. 20, 2015

Related U.S. Application Data
(60) Provisional application No. 61/943,034, filed on Feb. 21, 2014.

(51) Int. Cl. A47J 37/07

(52) U.S. Cl. CPC A47J 37/0704; A47J 37/0786

(57) ABSTRACT

The charbroiler of the present disclosure has a housing, and a plurality of separate and structurally distinct cooking zones within said housing. Each cooking zone has an associated cooking grate, a heating element, and a cover. The cover selectively lowers to cover the cooking grate, and raises to uncover it. A control system can control each cooking zone independently of one another, by controlling the amount of time the heating element is activated for, and/or at what temperature. The control system can also control the movement of the covers. The covers have shorter sides so that vapors or smoke emanating from the food product are directed toward a central axis or middle area of the charbroiler, or along exterior sides of the housing away from the user.

### CROSS-REFERENCE TO RELATED APPLICATIONS

The present application claims the benefit of U.S. Provisional Patent Application No. 61/943,034, filed on Feb. 21, 2014, which is herein incorporated by reference.

### BACKGROUND OF THE DISCLOSURE

1. Field of the Disclosure

The present disclosure relates to clamshell cooking devices. More particularly, the present disclosure relates to clamshell charbroilers having a plurality of cooking zones that can be independently controlled.

2. Description of the Related Art

There is a continuing need for cooking devices, such as grills or charbroilers, that are able to cook a variety of products and to reduce the time and difficulty associated with doing so. Many current devices only have one cooking surface that can be operated at a time, meaning that only one type of product can be prepared. Current grills may use flat platen-type cooking surfaces, which are typically set to one surface temperature. If the grills are set to different temperatures within the same platen (i.e., a flat plate cooking surface), this can be difficult to manage, since the platen cooking surface is one piece. Platen or flat-plate cooking surfaces also do not leave char marks on the food product or provide char-type grilling effects, which allow for smoking or additional flavor to be transferred to the food.

Many current charbroilers only cook from one side, and often involve one large grill area, requiring skilled labor to monitor the cooking operation, and meaning that cook times are slow. Current devices also allow for much of the flare or smoke caused by the cooking process to escape before they can transfer flavor to the food.

The present disclosure addresses these deficiencies.

### SUMMARY OF THE DISCLOSURE

The charbroiler of the present disclosure has one or more grate cooking zones. In an embodiment where there is a plurality of cooking zones, each can be independently controlled. This allows for different types of food products to be char-cooked independently of one another. The charbroiler has a clamshell cover associated with each cooking zone. The cover can have a heating element inside to cook the food from a side that is opposite the grate. This allows for more efficient cooking. In addition, the cover collects and entraps flare and smoke arising from the grate surface, the food, and the grate heater below. This imparts additional flavor to the food product. The covers can have elongated flaps on three sides, to help trap the flare and smoke. One of these flaps can be shorter than the others, to allow for venting in a particular location for better smoke management.

As used in the present disclosure, the term “charbroiler” refers to a cooking device having a slotted grate on which food product is cooked, and a grate heater below the grate to provide heat to the grate and the food product. If the grate heater is a gas burner, a shield can be used to protect the burner from food product that may drip or fall through the grate. Such drippings may hit the cover or other adjacent heated areas when they fall through the grate, providing flare-ups and/or smoke that can impart additional flavor to the food product. If the grate heater is an electric or induction heating element, it can be connected to, clamped, or otherwise affixed to an underside of the grate and or to the underside of the cover. Some of the surface of an electric or induction grate heater could be exposed to the food drippings, generating flare-up similar to the equivalent gas heating system. The grate can have a plurality of ribs that can impart char marks to the food product. The ribs are spaced apart.

Thus, in one embodiment, the present disclosure provides a charbroiler, comprising a housing, a plurality of cooking zones within the housing, and a control system. Each of the cooking zones has an associated cooking grate, a heating element on one side of the cooking grate, and a cover that selectively covers and uncovers a second side of the cooking grate. The control system controls operation of the heating element of each cooking zone independently of other heating elements, and controls operation of each of the covers independently of other covers. The cover may or may not have a heater within the cover, above the food, to heat or cook the food from above when the cover is in the deployed position over the food being cooked.

In another embodiment, the present disclosure provides a method of operating a charbroiler. The charbroiler comprises a housing and a plurality of cooking zones within the housing. Each of the cooking zones has an associated cooking grate, an associated heating element on one side of the cooking grate, and an associated cover that selectively covers and uncovers a second side of the cooking grate. The method comprising the steps of controlling operation of the heating element of each cooking zone independently of other heating elements, and controlling operation of each of the covers independently of other covers. Again, the cover may or may not have a heater within the cover, above the food, to heat or cook the food from above when the cover is in the deployed position over the food being cooked.

### BRIEF DESCRIPTION OF THE DRAWINGS

FIG. 1 is a top, perspective view of the charbroiler of the present disclosure, with all of the covers in open position;

FIG. 2 is a top, perspective view of the charbroiler of the present disclosure, with all of the covers in a closed position;

FIG. 3 is a top, perspective view of the charbroiler of the present disclosure, with two of the four covers open;

FIG. 4 is a top, perspective view of the charbroiler of the present disclosure, with food products placed on each of the cooking zones;

FIG. 5 is a top, perspective view of the charbroiler of the present disclosure, with food products placed on each of the cooking zones, and the closed covers in transparent view;

FIG. 6 is a top, perspective view of the charbroiler of the present disclosure, with the covers in open position, the grates in each cooking zone in a raised position, and a grease trap in an open position, representing the grill in an open cleaning position;

FIG. 7a shows a second embodiment of the charbroiler of the present disclosure;

FIG. 7b shows a third embodiment of the charbroiler of the present disclosure;

FIG. 7a shows a fourth embodiment of the charbroiler of the present disclosure;

FIG. 7a shows a fifth embodiment of the charbroiler of the present disclosure;

FIG. 7e shows a sixth embodiment of the charbroiler of the present disclosure;

FIG. 8a shows a top, perspective view of a seventh embodiment of the charbroiler of the present disclosure;

FIG. 8b shows a top, perspective view of the charbroiler of FIG. 8a, with the covers in an open position;

FIG. 8c shows a top, perspective view of the charbroiler of FIG. 8a, with two of the covers in an open position and food products placed on the exposed cooking zones;

FIG. 8d shows a top, perspective view of the charbroiler of FIG. 8a, with one of the covers in an open position, and food product placed on the exposed cooking zone;

FIG. 8e shows a top, perspective view of the charbroiler of FIG. 8a, with the covers in open position, the grates in each cooking zone in a raised position, and a grease trap in an open position, representing the grill in an open cleaning position;

FIG. 9a shows a top, perspective view of an eighth embodiment of the charbroiler of the present disclosure;

FIG. 9b shows a top, perspective view of the charbroiler of FIG. 9a, with two of the covers in an open position, and food product placed on the exposed cooking zones; and

FIG. 9c shows a top, perspective view of the charbroiler of FIG. 9a, with the covers in open position, the grates in each cooking zone in a raised position, and a grease trap in an open position, representing the grill in an open cleaning position.

### DETAILED DESCRIPTION OF THE DISCLOSURE

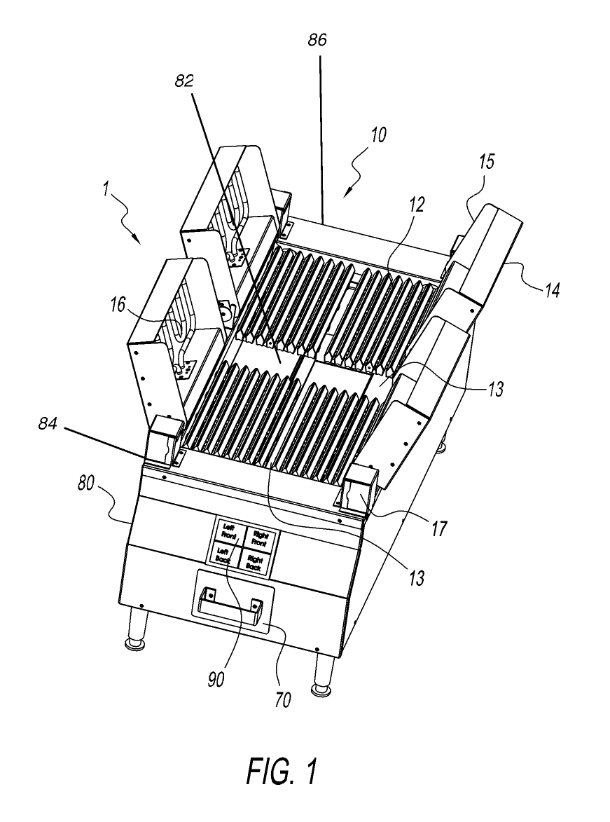

Referring to the Figures, and in particular FIG. 1, charbroiler 1 is shown. Charbroiler 1 has one or more cooking zones 10, each of which has grate 12 and clamshell cover 14. Grates 12 are all mounted in housing 80, but are structurally separate and distinct from each other. Each of zones 10 has an associated cover 14. Gaps 13 can separate adjacent grates 12. This arrangement allows for each of zones 10 to be operated independently of one another. As described in greater detail below, this means that a user can set each of zones 10 to different cooking times, temperatures, or other parameters related to cooking food products placed on grates 12. A user can set these parameters for each of cooking zones 10 through a user interface 90 that is in communication with a control system (not shown) in housing 80, that in turn operates each of cooking zones 10. Each of covers 14 has sides 15 that mostly enclose the food product and associated grate 12, and also partially retain and vent smoke and flare-up that arise therefrom, as discussed in greater detail below. Each of covers 14 also has a heating element 16 therein, to cook and/or brown the food product on grate 12 from a top side.

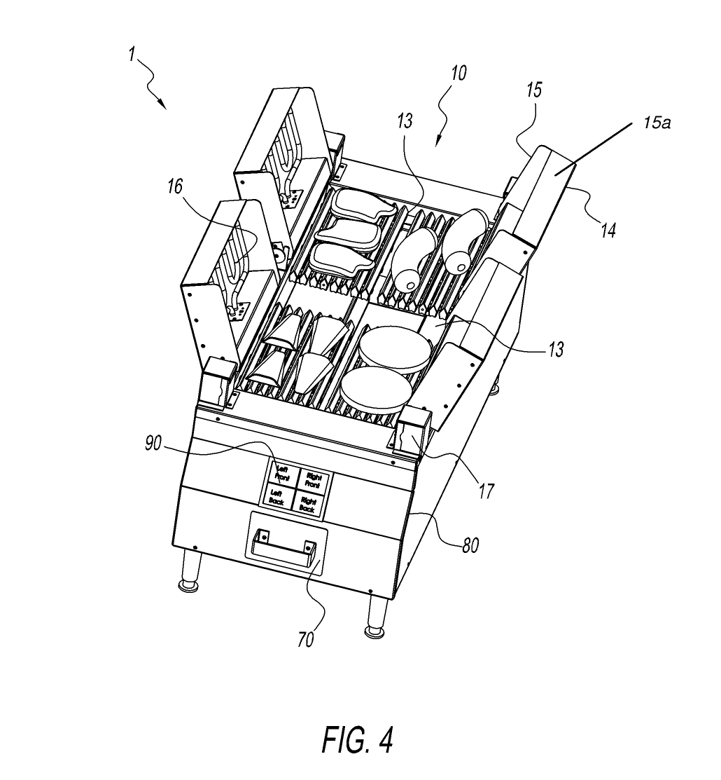

Charbroiler 1 thus provides several advantages over currently available devices. As each of zones 10 is independently operable and structurally separate from one another, one type of food product can be cooked on one of zones 10, and a different product utilizing different cooking times and temperatures can be cooked on a different zone 10 (FIG. 4). There is no concern for cross contamination between adjacent zones 10. In addition, covers 14 partially retain smoke and flare-up emanating from the food product being cooked. This provides additional smoking and flavoring lost in current charbroilers. Heating elements 16 improve the efficiency of charbroiler 1, reducing cooking time, since the food product does not need to be flipped. The automation of the cooking process allows for uniform product, desirable in many retail applications, and eliminates the need for an operator to interact with the food product until the cooking cycle is complete. The automating of covers 14 eliminates the possibility of removing food product from zone 10 before the cooking cycle is done. Covers can also be made to operate manually, such as with an override to the automated control.

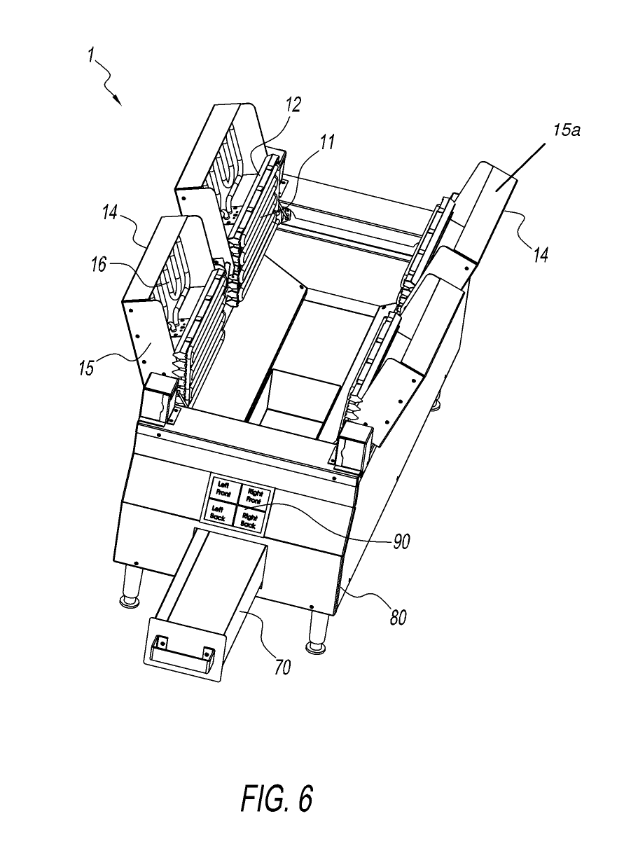

To use charbroiler 1, the user will place food product on the desired cooking zone 10, and select an appropriate program on interface 90. The program can be selected from pre-programmed ones stored in the control system. The control system closes cover 14 over the food product, and begins the cooking cycle by activating heating element 16 and a grate heater 11 (FIG. 6) beneath grate 12. In the embodiment of FIG. 6, grate heater 11 is an electric heating element that is clamped to an underside of grate 12. As discussed in greater detail below, other types of grate heaters 11 are contemplated. Alternatively, as previously discussed, cover 14 can be lowered and raised manually by the user.

The controller can control grate heater 11 beneath grate 12 and heating element 16 independently, by controlling them to operate at the same or different temperatures. The food product is thus heated from both sides. Advantageously, because of cover 14, the food product is also exposed to smoke and/or vapors caused by drippings from the food product contacting grate 12, the grate heater 11. Additional flare may be caused by drippings, smoke, or vapor contacting elements 16 within cover 14.

The control system can automatically raise covers 14 when the cooking cycle is done. An “open” position of covers 14 can be greater than ninety degrees from the horizontal, and a “closed” position for cooking can be at approximately horizontal orientation. Open or closed positions for cover 14 can also be anywhere between zero (i.e., horizontal) and ninety (i.e., vertical) degrees from the horizontal. The controller can provide an audible tone, a light, or other signal that the cooking process is done. At this point, the cover(s) 14 are raised, heating element(s) 16 is deactivated or controlled to a lower idle setting, and the grate heater 11 beneath grate 12 are deactivated or controlled to a lower idle setting. The grate heaters 11 can also be maintained in a heated state, for quick re-activation. The automation process thus provides additional operator safety. Alternatively, the user can operate covers 14 manually.

Covers 14 can rotate about hinges 17 that are mounted to the surface of housing 80. Hinges 17 can be opened to or locked at any angle from zero to ninety degrees or greater with respect to the horizontal, as discussed above. Hinges 17 can be controlled automatically, or manually adjusted. Hinges 17 can be any device that enables the desired degree of rotation and locking ability, such as a ratchet hinge. Hinges 17 may also be releasably connected, so that covers 14 can be removed.

Charbroiler 1 and its control system could also be made to operate independently of pre-programmed recipes, to accommodate a special order or to experiment with recipes not previously programmed into the system. This could be achieved with an override to the control system, or by any other operator controllable setting that disengages or overrides the control system.

The control system can also operate each of zones 10 in a cleaning cycle. In the cleaning cycle, each of zones 10 can be set to heat to a sufficient temperature to cook off all the buildup in the cook grate, then cooled back to a cooking temperature where it could be easily cleaned of the remaining ash on the grate, re-seasoned for use again. This cleaning cycle could occur while other zones 10 are cooking food product. The control system can also operate any or all of zones 10 in a standby mode. In this standby mode, covers 14 can be deployed over the associated grate 12, and the grate temperature is maintained in a covered environment at a reduced temperature. This lowers the energy required to maintain a cooking temperature in the zone 10, and yet reduce the amount of time it would take to bring zone 10 up to the cooking temperature when required.

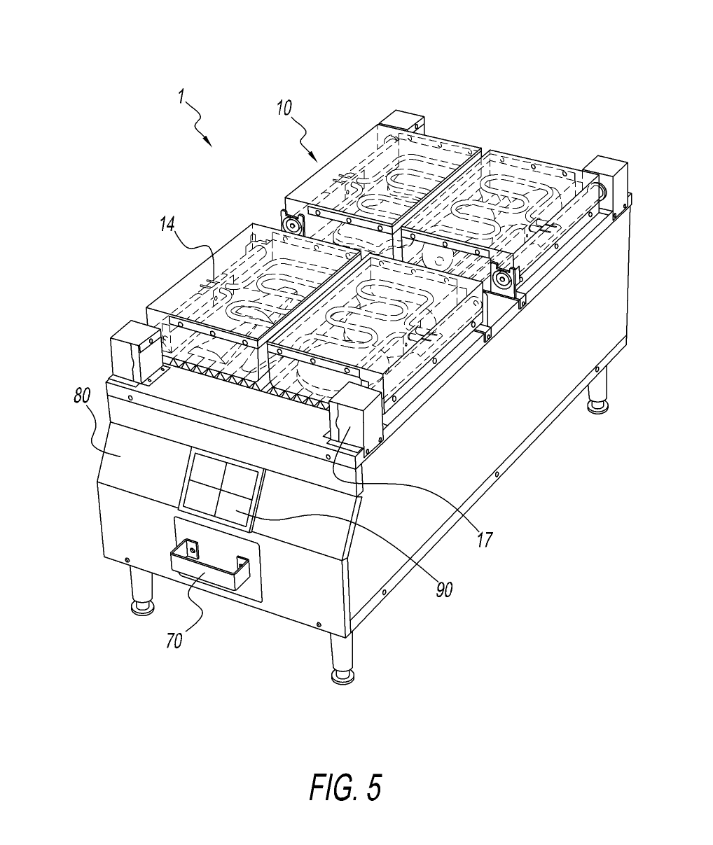

In the embodiment of FIGS. 1-6, there are four separate cooking zones 10, in a two-by-two arrangement. The covers 14 are oriented so that they open in a direction away from the centerline of charbroiler 1. The present disclosure contemplates one or more of cooking zones 10, in a variety of arrangements. Charbroiler 1 can have one zone 10, two zones 10, four zones 10, or more than four zones 10. In use, one or more of zones 10 can be operated to cook product, while other zones 10 are not heated or in use. For example, one zone 10, a plurality of zones 10, or all of zones 10 can be used simultaneously to cook food product. Shutting off adjacent zones 10 that are not in use can improve the energy efficiency of charbroiler 1, and provide for worker safety, as the risk of burn or discomfort is reduced. The status of each cooking zone can be controlled by the control system, or manually by the operator.

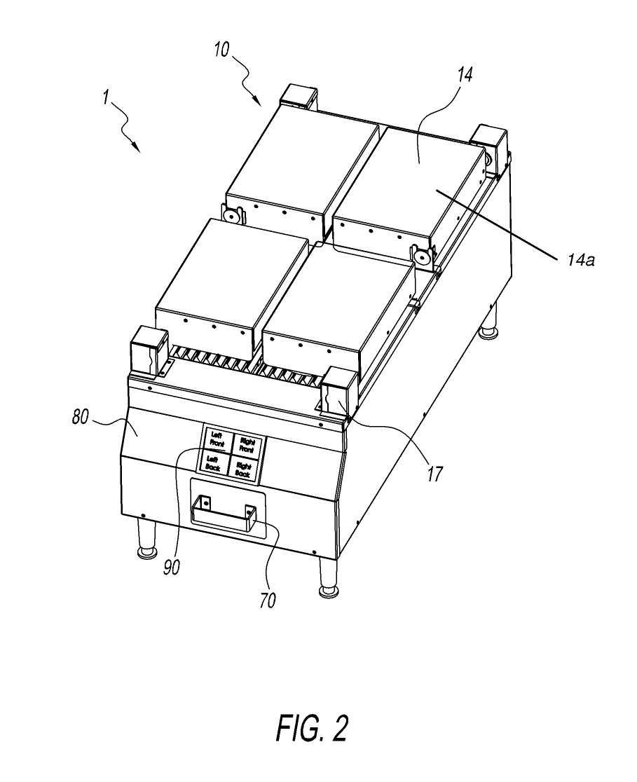

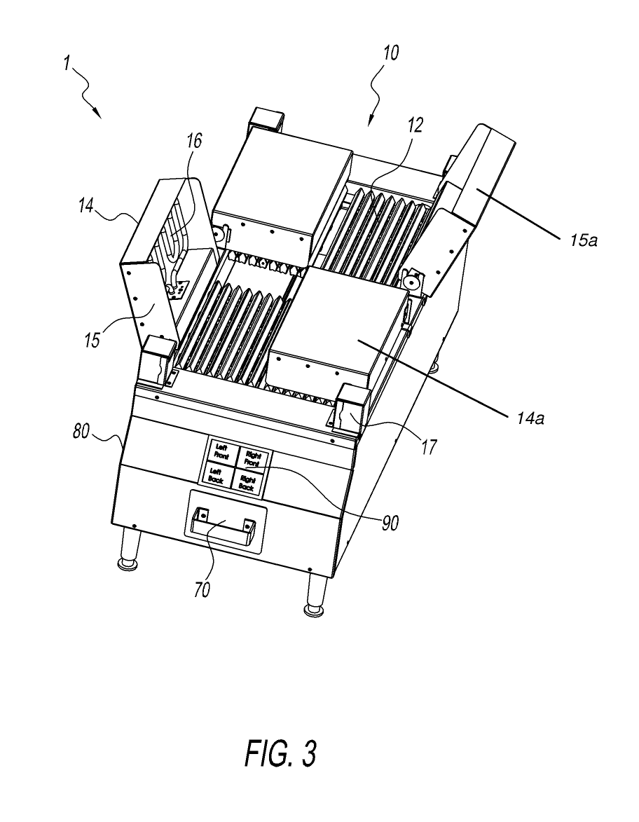

As discussed above, this smoke is partially collected by cover 14. In one embodiment, each of covers 14 has a planar surface 14a (FIGS. 2 and 3) and three sides 15 projecting from that planar surface. At least one of sides 15 can be shorter than the others (shown as side 15a in FIGS. 1, 3, 4, and 6), so that the smoke and/or vapors under cover 14 can vent from the shortest side 15a. In the shown embodiment, the shortest side 15a of each of covers 14 is along a central axis of charbroiler 1, so that the smoke and/or vapors vent toward the center axis or area 82. Stated another way, housing 80 can be generally rectangular, and have a first axis or width. Control panel 90 is located along this first axis or width, and the user would typically stand along this axis to operate charbroiler 1. Housing 80 also has a second axis that is perpendicular to the first axis, and which is typically longer than the first axis. Covers 14 can rotate about and open along this second axis, so that the steam, vapors, or smoke they contain are not directed toward an operator or user upon opening. In the shown embodiment, as described above, the steam, vapor, or smoke is directed toward central area 82. However, the present disclosure also contemplates that the steam, vapor, or smoke may be vented at hinges 17, or along an exterior edge 84 or rear edge 86 of housing 80.

This is yet another advantage of charbroiler 1. In currently available devices, when the food product is removed at the end of a cooking cycle, the clamshell upper surfaces open in a way that allows for the escape of vapors during the process of lifting the clamshell. This creates a plume of smoke, steam, and grease-laden vapor that travels in an outward direction and away from a ventilation hood that is typically disposed over the device, making the plume difficult to capture by the ventilation system. The present disclosure solves this problem by opening the clamshell covers 14 from a side pivot position, directing the vapor plume in a direction parallel with the ventilation system, and making it easy to capture the vapors.

As shown in FIG. 6, charbroiler 1 has features that provide easy access for cleaning. To clean the interior of charbroiler 1, each grate 12 and cover 14 of each of the zones 10 can be raised up to provide access. A drawer 70 can be near the bottom of charbroiler 1, and collect any charred food, grease or debris. Drawer 70 can be easily slid or removed from charbroiler 1 to dispose of the collected debris.

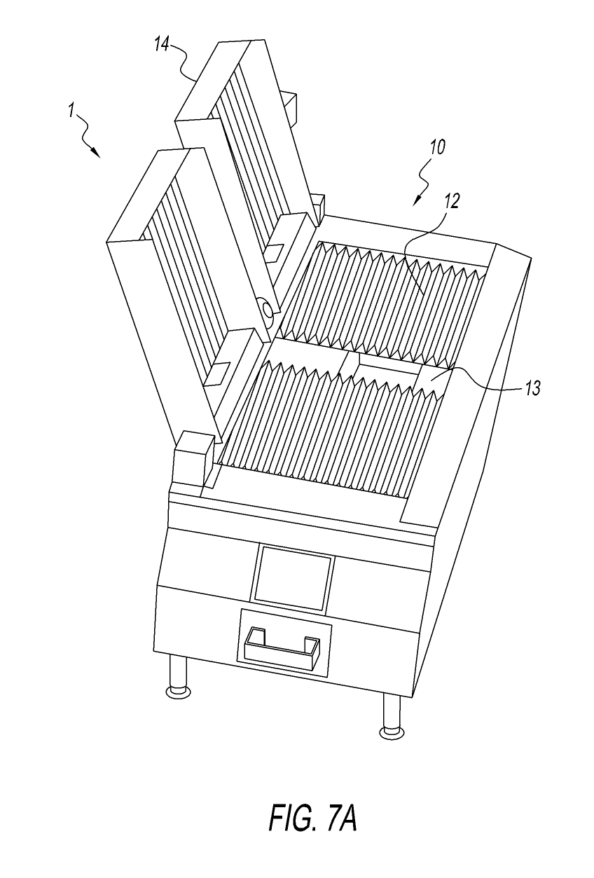

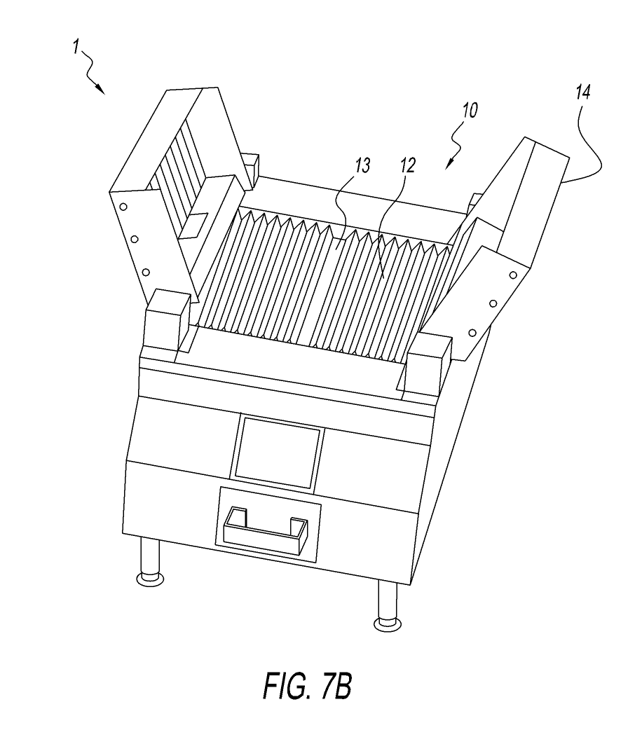

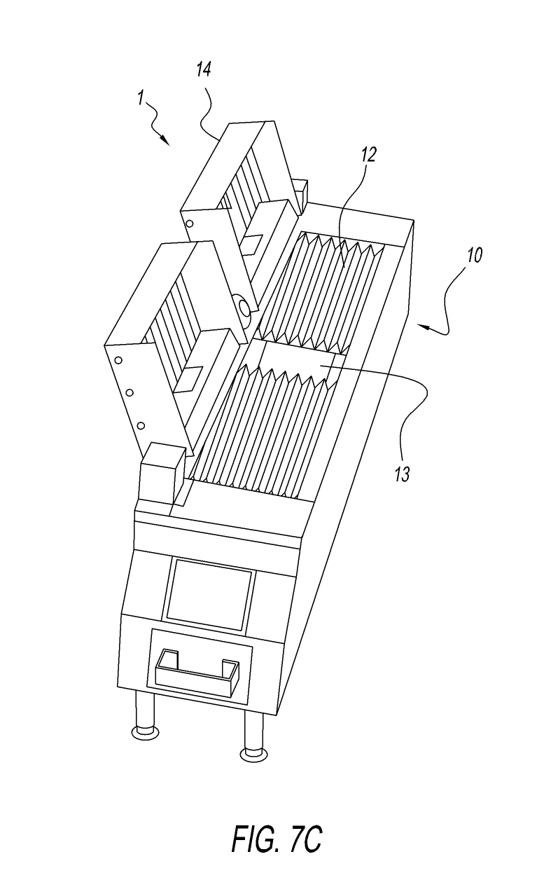

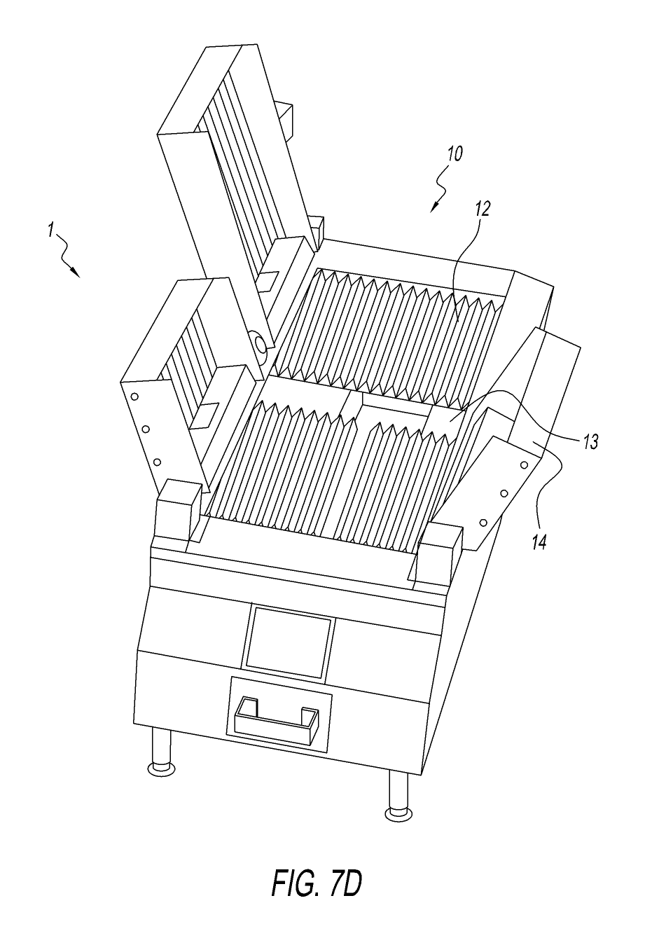

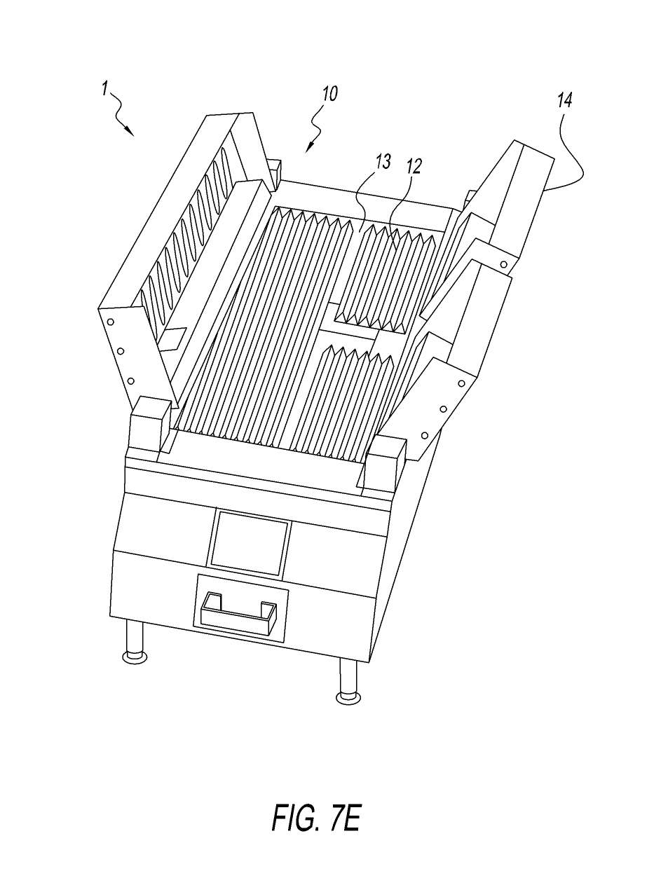

Referring to FIGS. 7a -7e, different embodiments of charbroiler 1 that fit the requirements of different users and applications are shown. Some users may have space restrictions for example, or others may only need small volume charbroilers. Others may have larger footprint and/or cooking volume or capacity requirements that are better accommodated by differently sized or configured systems. These embodiments of charbroiler 1 could include single zone, double zone, or triple zone configurations. In FIG. 7a, charbroiler 1 has a two-by-one configuration of large zones 10. FIGS. 7b and 7c show one-by-two and two-by-one arrangements of zones 10, respectively, and consequently the overall footprint of charbroiler 1 in these embodiments can be made smaller or larger than that of the embodiments of FIGS. 1-6. In the embodiment of FIG. 7b, the first axis, along which the user stands, is longer than the second axis, about which the covers 14 would rotate and open. In FIGS. 7d, and 7e, charbroiler 1 has three zones 10, one of which is larger than the size of the other two. Thus, charbroiler 1 provides versatility in grill design and space.

As previously discussed, heating element 16 is a non-contact radiant element. Non-contact heaters can be advantageous in that they don't require precise positioning, as do the platen-based heaters currently available. They also do not need to be cleaned after each cooking cycle, making them more user friendly. However, the present disclosure contemplates that either element 16 or the grate heater 11 under grate 12 can be electric (e.g., radiant elements) or gas burners. Gas burners can be powered or atmospheric. Furthermore, grate 12 could be a flat grill plate with a heating element under it. Cover 14 may also have contact plates or grates therein as well. These latter embodiments could involve heating plates that contact the food product from above, and have the associated positioning controls for the same. One or more of zones 10 could also be operated without a cover 14, and be an open-air grill plate. In the embodiments that enable contact with the food surface, such contact may be pre-programmed into recipe profiles and/or achieved by sophisticated product recognition systems that adjust to the various heights of food products or desired amount of pressure exerted on the food product. This adjustment could take place one or more times during the cooking process, with each zone being independently controllable.

Alternatively, other heat sources such as induction heaters could be used, with the induction members configured to leave grill markings on one or both sides of the food. Such induction heaters could be used in both grate 12 and cover 14, with holes or apertures in the lower induction grate to enable grease and other affluence to pass through. Induction could also be used as the heat source on grate 12 only, with radiant heating in cover 14, capable of marking or not marking the food product. The types of heating sources used could also be varied within charbroiler 1, from front to back zones 10, or side to side. For example, a gas burner could be used in one zone 10, and induction or radiant in another zone 10.

The cooking environment in charbroiler 1 can also be controlled by a combination of temperature, time, and/or product recognition. The appropriate controls and cooking parameters could be automatically adjusted according to a recipe profile in the control system, or manually adjustable by an operator. This allows, for example, a steak that could be cooked from rare to well-done depending on customer preference.

Interchangeable grill plates with different marking patterns could be used to further add flexibility and/or enable special markings to be made upon the food surface. Different cooking zones could use different grill plates each having different grill markings.

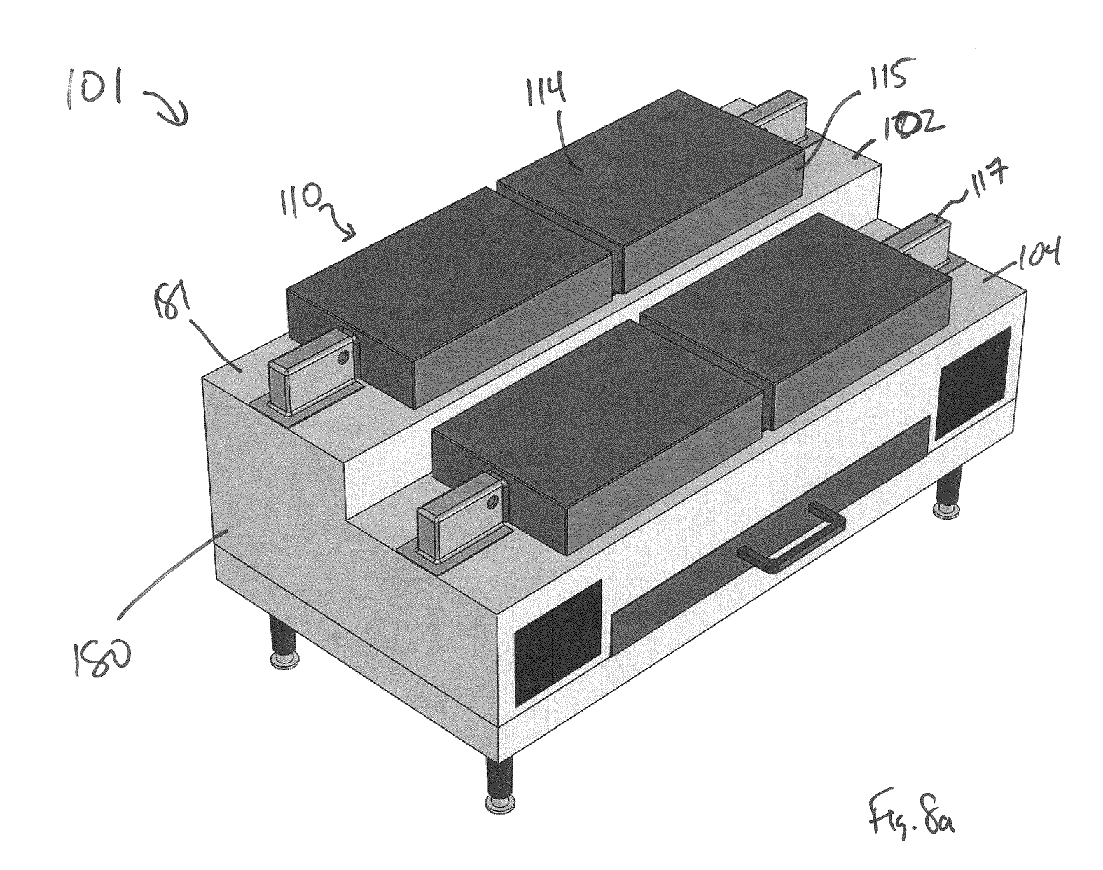

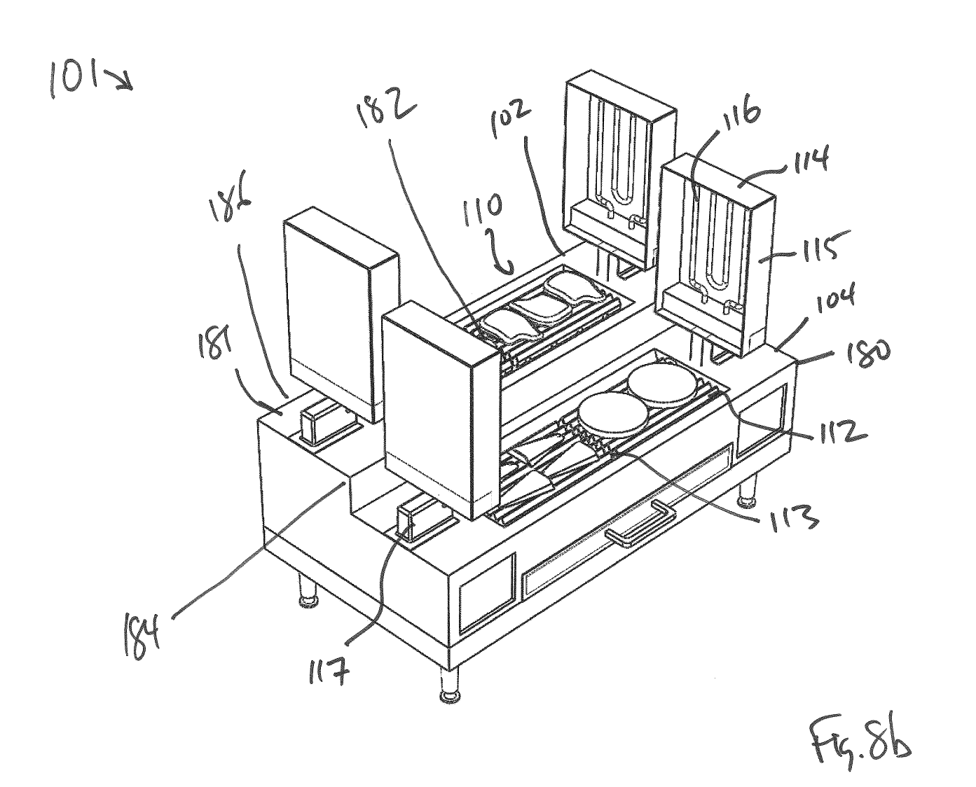

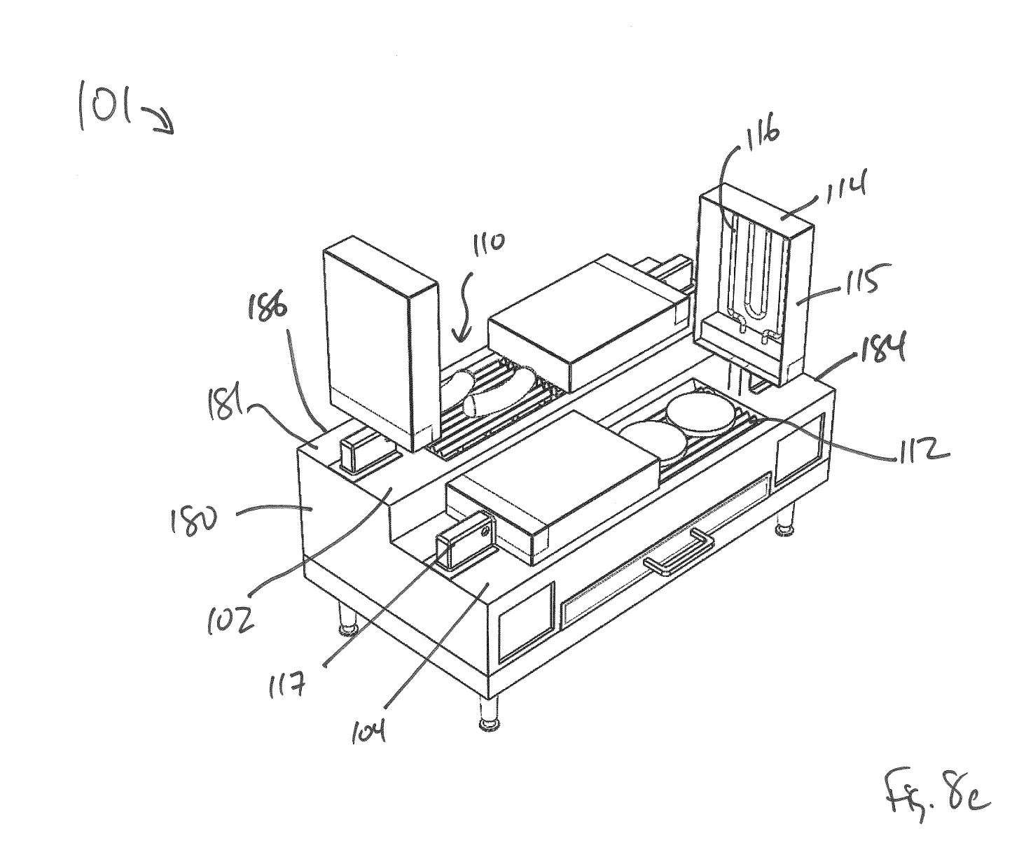

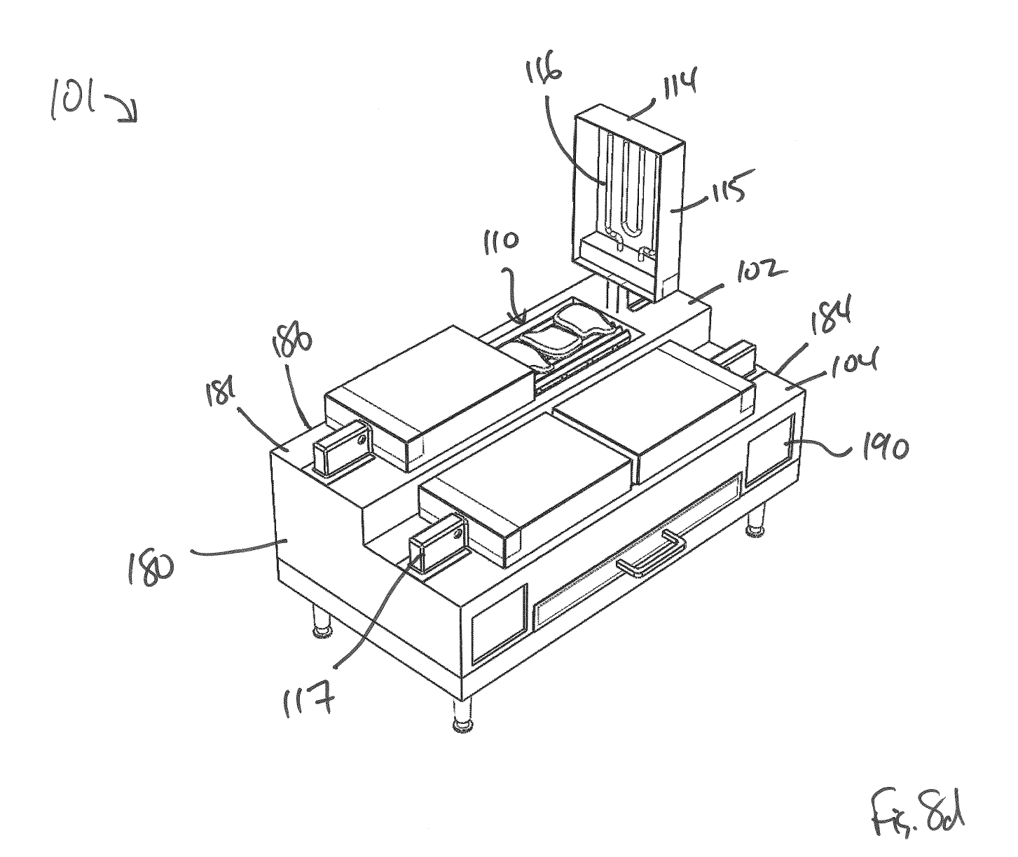

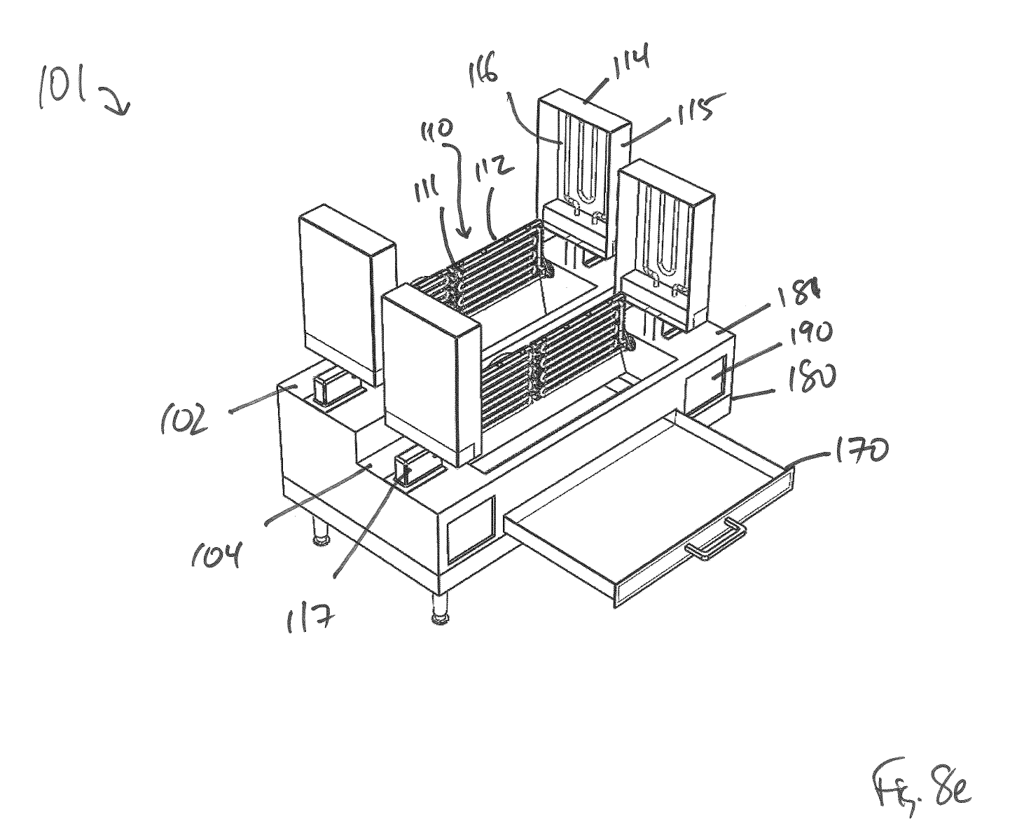

Referring to FIGS. 8a -8e, an alternative embodiment of the charbroiler of the present disclosure is shown, and referred to by numeral 101. Charbroiler 101 has one or more cooking zones 110, each of which has grate 112 and clamshell cover 114. Grates 112 are all mounted in housing 180, but are structurally separate and distinct from each other. Each of zones 110 has an associated cover 114. Gaps 113 can separate adjacent grates 112. Each grate 112 has an associated grate heater 111 (FIG. 8e). Each of covers 114 has sides 115 that mostly enclose the food product and associated grate 112, and also partially retain and vent smoke and flare-up that arise therefrom. Each of covers 114 can also have a heating element 116 therein, to cook and/or brown the food product on grate 112 from a top side. Covers 114 can rotate about hinges 117 that are mounted to the surface of housing 180. Housing 180 can have a central axis or area 182, a rear edge 186, and a side or exterior edge 184. A control system embedded within charbroiler 101 can be accessed through a user interface 190 on housing 180.

Thus, charbroiler 101 functions in a similar manner to charbroiler 1 described above, with the exceptions described below. Charbroiler 101 has a multi-tiered structure, wherein a top surface 181 of housing 180 has a first tier 102 that is at a different height than a second tier 104. Each of first tier 102 and second tier 104 can have at least one cooking zone 110 thereon, or a plurality of cooking zones 110 thereon. Having a multi-tiered top surface 181 allows an operator to access different cooking zones 110 more easily. For example, the operator can stand adjacent to the lower tier, which in the shown embodiment is tier 104. When trying to access cooking zones 110 on the higher, first tier 102, the operator has more clearance when reaching over the zones 110 on lower, second tier 104. Although the embodiment of FIGS. 8a -8e has two tiers, the present disclosure contemplates a plurality of tiers, such as three or more.

In the embodiment of FIGS. 8a -8e, covers 114 rotate about hinges 117, toward exterior edge 184. Similarly to charbroiler 1, this allows any smoke or vapor that accumulates within cover 114 to vent toward central axis or area 182. Also as in charbroiler 1, one of sides 115 of cover 114 can be shorter than the others, to facilitate the release of the smoke or vapor.

Referring specifically to FIG. 8e, drawer 170 is shown. Drawer 170 operates in a similar fashion to that of drawer 70 of charbroiler 1. Namely, drawer 170 can sit below zones 110 and grates 112, and catch any food drippings or grease that may fall therethrough. During a cleaning operation, a user can slide drawer 170 out of housing 180, and dispose of the food debris.

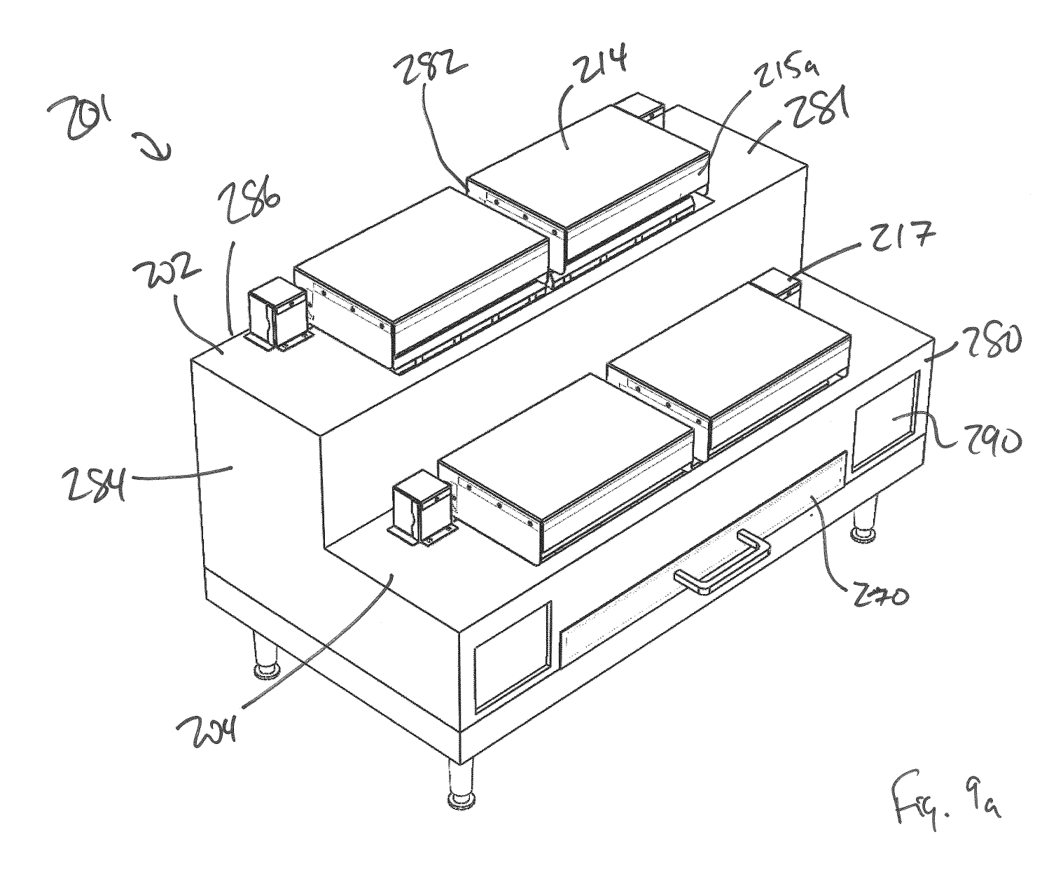

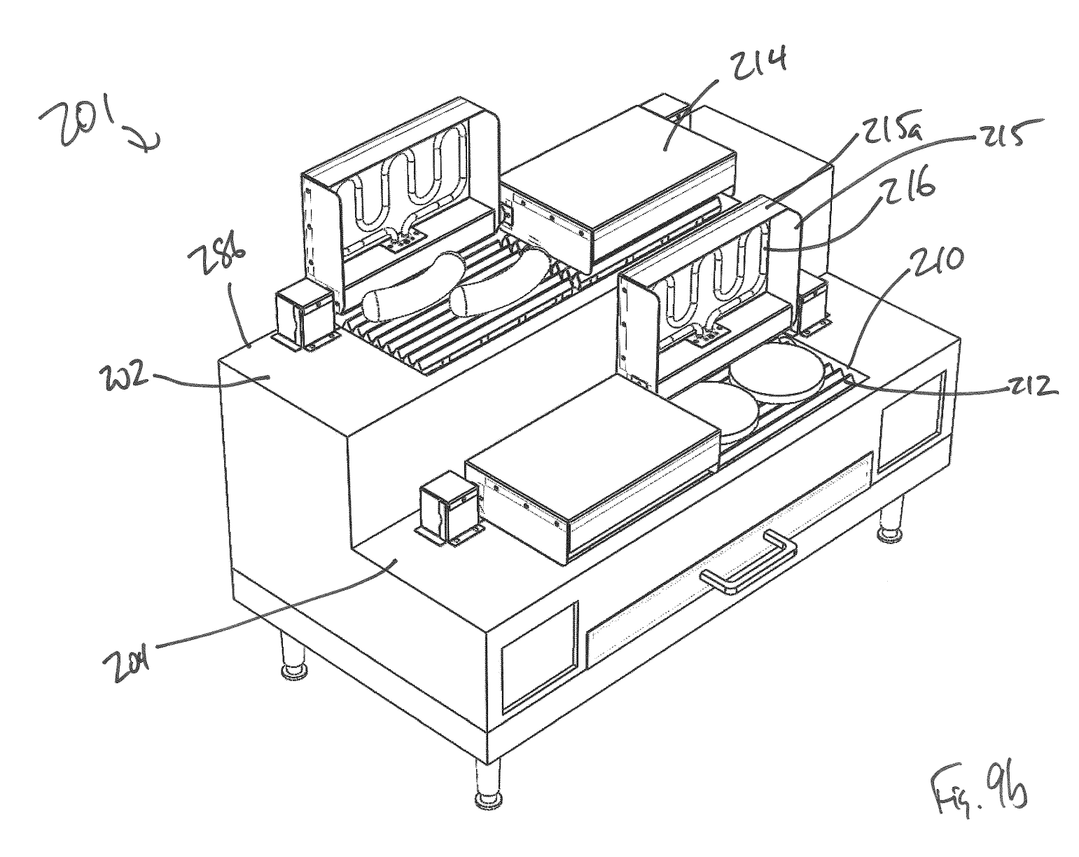

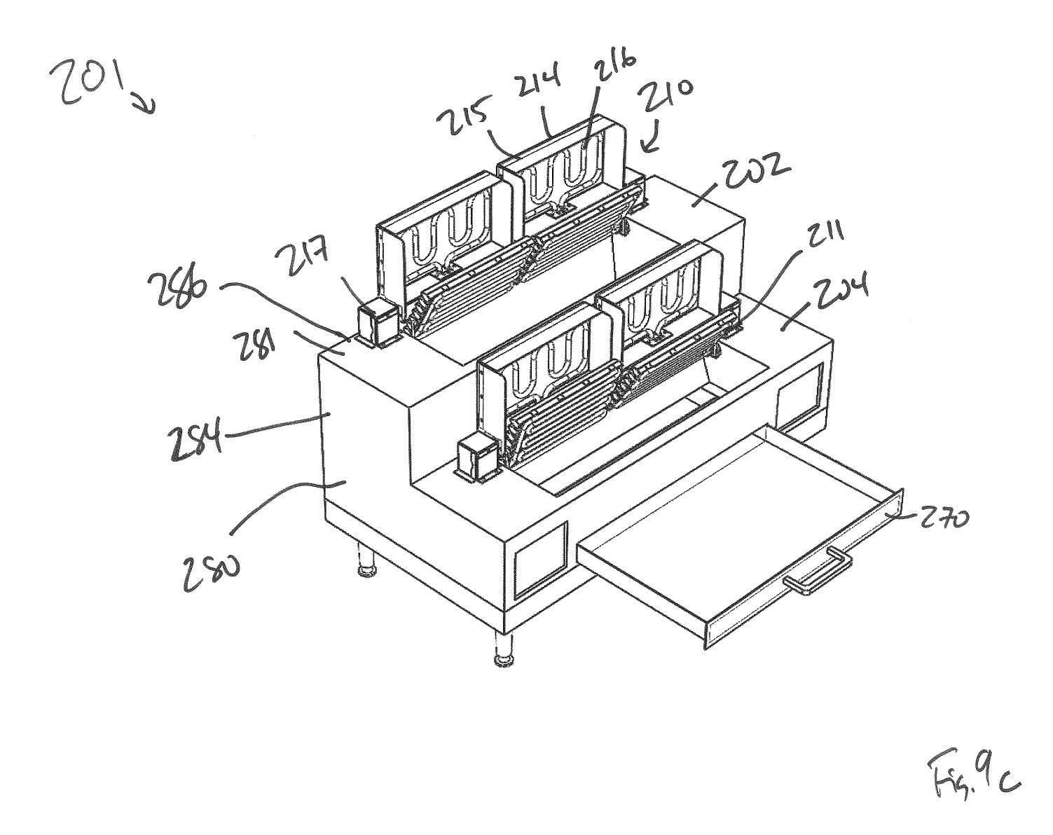

Referring to FIGS. 9a -9c, charbroiler 201 of the present disclosure is shown. Charbroiler 201 has a plurality of cooking zones 210, each of which has an associated cooking grate 212, grate heater 211 (FIG. 9c), and cover 214. Cover 214 has a plurality of sides 215, and a heating element 216 within. Each of covers 214 rotates about an associated hinge 217. Charbroiler 201 also has housing 280, with rear edge 286 and side or exterior edge 284. A drawer 270 can slide in and out of housing 280, and can collect food debris that drops from grate 212. A control system of charbroiler 201 can be manipulated through user interface 290.

Charbroiler 201 operates in an almost identical fashion to charbroiler 101, in that housing 280 has a top surface 281 with two tiers, first tier 202 and second tier 204. Second tier 204 is lower than first tier 202. The main difference between charbroiler 202 and charbroiler 201 is that covers 214 rotate about hinges 217 so that they tilt back toward rear edge 286 of housing 280. Thus, if a user were to stand in front of drawer 270, covers 214 would rotate back away from the user. The shortest side 215a of covers 214 can face the user. Thus, covers 214 do not necessary vent toward a central area or axis 282 of charbroiler 201. The present disclosure contemplates placing shortest side 215a within a central area 282, to facilitate more of the smoke and vapor being directed this way.

Unless otherwise specified, any of the features described above with respect to charbroiler 1 apply to charbroiler 101 and charbroiler 201. This includes, but is not limited to, automatic and manual control relating to the motion of the covers, the various heating operations relating to the grate heaters and heating elements within the covers, the types of heaters used, and the cleaning operations described above.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof.

Therefore, it is intended that the disclosure not be limited to the particular embodiments disclosed as the best mode contemplated for carrying out this disclosure.

What is claimed is:

1. A charbroiler, comprising:
a housing;
a plurality of cooking zones within said housing; and
a control system,
wherein each of said cooking zones has an associated cooking grate, a heating element on one side of said cooking grate, and a cover that selectively covers and uncovers a second side of said cooking grate, and
wherein said control system controls operation of said heating element of each cooking zone independently of other heating elements, and controls operation of each of said covers independently of other covers.

2. The charbroiler of claim 1, wherein each of said covers comprises a second heating element therein, so that said second heating element heats said cooking grate on said second side.

3. The charbroiler of claim 1, wherein each of said cooking grates are separate from one another and structurally distinct.

4. The charbroiler of claim 3, wherein there is an air gap between each of said cooking grates.

5. The charbroiler of claim 1, wherein each of said covers has a planar surface and three sides projecting from said planar surface.

6. The charbroiler of claim 5, wherein one of said sides is shorter than the other two.

7. The charbroiler of claim 6, wherein said housing has a first axis, and a second axis that is longer than said first axis, and wherein said shorter side of said cover is along said second axis of said housing.

8. The charbroiler of claim 7, wherein each of said covers pivots about said second axis, so that when said cover rotates into an open position, smoke or vapors contained therein will be released from said shorter side along said second axis.

9. The charbroiler of claim 1, wherein said heating element is an electric heating element.

10. The charbroiler of claim 1, wherein said heating element is a gas combustion heating element.

11. The charbroiler of claim 2, wherein said second heating element is an electric or induction heating element.

12. The charbroiler of claim 1, further comprising a drawer within said housing and below each of said cooking zones, for collecting grease and food debris that falls from said cooking grates.

13. The charbroiler of claim 1, wherein said cooking grate is a slotted grate having a plurality of ribs and a space between each of said ribs, so that char marks are imparted to a food product cooked thereon.

14. The charbroiler of claim 1, wherein said housing has a top surface, and said top surface has a first tier and a second tier, wherein said first tier is higher than said second tier, and each of said first tier and said second tier has at least one of said plurality of cooking zones therein.

15. The charbroiler of claim 14, wherein said housing has a central area, wherein each of said covers has an associated hinge, and wherein each of said covers rotates about said associated hinge in a direction away from said central area.

16. The charbroiler of claim 14, wherein said housing has a rear edge, wherein each of said covers has an associated hinge, and wherein each of said covers rotates about said associated hinge in a direction toward said rear edge.

17. A method of operating a charbroiler, the charbroiler comprising:
a housing; and
a plurality of cooking zones within said housing, wherein each of said cooking zones has an associated cooking grate, an associated heating element on one side of said cooking grate, and an associated cover that selectively covers and uncovers a second side of said cooking grate,
the method comprising the steps of:
controlling operation of said heating element of each cooking zone independently of other heating elements; and
controlling operation of each of said covers independently of other covers.

18. The method of claim 17, further comprising the steps of:
turning one of said heating elements associated with one of said cooking zones on for a set period of time or at a set temperature;
lowering said cover associated with said cooking zones so that it covers said associated cooking grate; and
after said set period of time expires, raising said cover away from said cooking grate, and reducing said temperature of said heating element.

19. The method of claim 17, wherein said controlling operation of each of said covers step comprises controlling each of said covers to cover and uncover each of said cooking zones automatically.

20. The method of claim 17, wherein said step controlling operation of each of said covers comprises controlling each of said covers to cover and uncovers each of said cooking zones manually.

21. The method of claim 17, further comprising the step of raising the temperature of at least one of said heating elements to a point at which food product on said associate cooking grate burns off.

22. The method of claim 17, wherein each of said covers comprises a second heating element therein, so that said second heating element heats said cooking grate on said second side.

23. The method of claim 17, wherein each of said cooking grates is separate from one another and structurally distinct.

24. The method of claim 17, wherein there is an air gap between each of said cooking grates.

25. The method of claim 18, wherein each of said covers has an associated second heating element within said cover, and the method further comprises the step of controlling an output of said second heating element.

26. The method of claim 25, wherein said second heating element can be controlled to operate for only a portion of said set period of time.
